(19) United States
(12) Patent Application Publication
(10) Pub. No.: US 2010/0044281 A1
(43) Pub. Date: Feb. 25, 2010

(54) SCREENING PANEL SECURING SYSTEM

(75) Inventors: Ronald Johnson, Geebung (AU); Warren Anthony Spinks, Geebung (AU); Ronald McGregor, Geebung (AU)

Correspondence Address: (Weatherford) Wong Cabello Lutsch Rutherford &;Brucculeri LLP, 20333 Tomball Parkway, 6th floor, Houston, TX, 77070, US

(73) Assignee: JOHNSON SCEENS (AUSTRALIA) 4034, GEEBUNG QUEENSLAND (AU)

(21) Appl. No.: 12/440,883

(22) PCT Filed: Aug. 30, 2007
(86) PCT No.: PCT/AU07/01256

§ 371 Date: Mar. 11, 2009

(30) Foreign Application Priority Data
Dec. 22, 2006 (AU) 2006907326
Feb. 14, 2007 (AU) 2007200706

(51) Int. Cl. B07B 1/46; F16B 1/00; B07B 1/04

(52) U.S. Cl. 209/399; 209/409; 403/319; 209/405

(57) ABSTRACT

A screening assembly 10 includes at least one rail 14 to be secured to a support member of a screening machine to lie parallel to, and intermediate, side members of the screening machine. At least one retaining formation 18 stands proud of an operatively upper surface of each rail 14. The assembly includes a plurality of screening modules 12. Each screening module 12 comprises a supporting structure 64 and a removable screening element 66. The supporting structure 64 has an end supported on the rail 14 so that a pair of supporting structures 64 lie in end-to-end abutting relationship with the abutting ends, in use, overlying the rail 12 and defining a receiving formation through which the retaining formation 18 protrudes to project beyond the receiving formation into a recessed region defined by the abutting ends of the pair of supporting structures 64. A locking member 46 is associated with the receiving formation and is receivable in the recessed region for engaging its associated retaining formation to lock the pair of supporting structures with respect to each other and with respect to the rail 14. An upper surface of the locking member 46, when the locking member is received in the recessed region, lies substantially at or below the level of an operatively upper edge of the supporting structure.

### CROSS-REFERENCE TO RELATED APPLICATIONS

The present application claims priority from Australian Provisional Patent Application No 2006907326 filed on 22 Dec. 2006 and Australian Complete Patent Application No 2007200706 filed on 14 Feb. 2007, the contents of each of which is incorporated herein by reference.

### SUMMARY OF THE INVENTION

According to a first aspect of the invention, there is provided a screening assembly including:

at least one rail to be secured to a screening machine;

at least one retaining formation an upper surface of said at least one rail;

a plurality of screening modules, each screening module comprising:
a supporting structure; and
a removable screening element attached to the supporting structure;

the supporting structure having an end supported on said at least one rail so that a pair of supporting structures lie in end-to-end abutting relationship overlying the at least one rail and defining a receiving formation through which the at least one retaining formation protrudes into a recessed region defined by the abutting ends of the pair of supporting structures; and

a locking member receivable in said recessed region.

In use, an upper surface of the, or each, locking member, when the locking member is received in the recessed region, will preferably be located below an upper edge of the supporting structure.

The assembly may include a plurality of retaining formations arranged at longitudinally spaced intervals along the length of the rail, at least one retaining formation being associated with each pair of screening modules. If desired, two such retaining formations may be associated with each pair of modules.

Those skilled in the art will appreciate that, in general, the screening modules are substantially rectangular when viewed in plan and have their shorter sides arranged in a direction of flow of material over the screening modules. The ends of the screening modules may be the shorter sides of the screening modules which are received over their associated rails.

Further, it will be appreciated that, where each pair of modules is secured to the rail by more than one retaining formation, the same number of parts of receiving formations and recessed regions may be arranged at spaced intervals along each end of each module.

Each retaining formation may be in the form of a hook defining a groove within which an engaging part of the locking member is received. The engaging part of the locking member may be a tongue which extends transversely to the ends of the screening modules to engage the hook of the associated retaining formation.

The recessed region, when viewed in a vertical plane, may be a sector of a circle or may be semi-circular in shape. The locking member may have a complementary sector or semi-circular shape with a flat upper surface to be snugly received in the recessed region and preferably completely contained below an upper edge of the supporting structure.

A floor of the recessed region may carry transverse ribs on which the locking member is received and relative to which the locking member can slide to facilitate locking insertion of the locking member into the recessed region.

It will be appreciated that, because the modules of each pair of modules abut in end-to-end relationship, each end of the screening supporting structure may define a part of the receiving formation and recessed region so that, when the two modules are placed in end-to-end abutment, the completed receiving formation and recessed region are formed.

The supporting structure may have one or more profiled peripheral projections for attachment of the removable screening element and the removable screening element may be provided with one or more peripheral retention slots having a cross-section which co-operates with the profiled peripheral projections to retain the removable screening element on the supporting structure. Preferably the profiled peripheral projections have a profile which includes a wider distal portion acting as a detent to create a snapping action when the removable screening element is attached to the projections.

Faces of the removable screening element that press against sides of the locking members may be provided with restraining formations that co-operate with complementary formations on the locking members to prevent rotational movement of the locking members when in use. In one advantageous form the restraining formations on the removable screening elements are grooves which co-operate with projections on the locking members, however it will be appreciated that the locations of the grooves and projections may also be reversed.

Each rail may comprise an elongate member having a generally rectangular cross-section with the retaining formations being secured to one of the wider faces of the rectangular section. Preferably the rectangular cross-section member will be formed on a C-section metal reinforcing member such that the rectangular cross-section member is hollow and open on the side opposite the surface carrying the retaining formations. Each rail may also be provided with flanges to shield underlying sub-frame members of the screening machine to which the rails are fitted. The flanges may extend from corners of the rectangular section opposite the face from which the retaining formations project. Locating formations, which may be in the form of lugs, may be provided on the face from which the retaining formations project to provide positive location for the supporting structures.

An operatively lower surface of each supporting structure may be stepped at its end to overlie a portion of the rail so that, when the modules are arranged in end-to-end abutment, a channel is formed within which the rail is received. The stepped end will preferably overlie the face of the rail from which the retaining formations and lugs project. The under surfaces of the stepped end of the supporting structures may be provided with recesses which snugly fit over the locating formations or lugs to locate the supporting structure on the rail and restrain it against movement in the flow direction.

The rail and its associated locating and retaining formations may be of metal-reinforced plastics. Similarly, the locking member may also be of a plastics material and may have metal reinforcing therein. The modules may also be of a plastics material suitably reinforced. Conveniently, all the plastics materials may be polyurethane materials. It is important that the hardness of the plastics material used for the locking member differs from that of the modules to inhibit binding of the locking member relative to its associated modules. Typically, the locking member may be of a harder plastics material than the modules.

According to a second aspect of the invention, there is provided a screening module for a screening assembly, the screening module including:

a supporting structure having a pair of opposed ends;

a removable screen located over the supporting member;

a part of at least one receiving formation defined in at least one of the ends of the supporting structure, the part of the receiving formation, operatively co-operating with a corresponding part of a receiving formation of a supporting structure of a similar module arranged in end-to-end abutment; and

a part of a recessed region associated with the, or each, receiving formation in said at least one end of the supporting structure, the part of the recessed region similarly co-operating with a corresponding part of a recessed region of the supporting structure of the identical module when arranged in end-to-end abutment.

According to a third aspect of the invention, there is provided a supporting structure of a screening module for a screening assembly, the supporting structure including:

a frame having a pair of opposed ends and arranged to receive a removable screen located over the supporting member;

a part of at least one receiving formation defined in at least one of the ends of the frame, the part of the receiving formation, operatively co-operating with a corresponding part of a receiving formation of a frame of a similar supporting structure arranged in end-to-end abutment; and

a part of a recessed region associated with the, or each, receiving formation in said at least one end of the frame, the part of the recessed region similarly co-operating with a corresponding part of a recessed region of the frame of the identical supporting structure when arranged in end-to-end abutment.

Each end of the support structure may be stepped at its operatively lower edge to overlie a portion of a supporting rail of the screening assembly. The stepped end will preferably overlie a face of the rail from which the retaining formations project.

According to a fourth aspect of the invention, there is provided a removable screening element of a screening module for a screening assembly, the screening module comprising a supporting structure having a pair of opposed ends, a part of at least one receiving formation defined in at least one of the ends of the supporting structure, the part of the receiving formation operatively co-operating with a corresponding part of a receiving formation of a supporting structure of a similar module arranged in end-to-end abutment; and

a part of a recessed region associated with the, or each, receiving formation in said at least one end of the supporting structure, the part of the recessed region similarly co-operating with a corresponding part of a recessed region of the supporting structure of the identical module when arranged in end-to-end abutment, said part of the recessed region being in shape, a sector of a circle or semi-circular, in a plane of the at least one end of the supporting structure, the screening element comprising:

a planar perforated screening member arranged with attachment means around its periphery for removable attachment to a said supporting structure.

According to a fifth aspect of the invention, there is provided an intermediate rail for a screening assembly, the intermediate rail including:

an elongate element to be secured to a screening machine; and

at least one retaining formation standing proud of a surface of said elongate element.

According to a sixth aspect of the invention, there is provided a locking member for a screening assembly, the locking member including:

a body member having an arcuate periphery, when viewed from a side of the body member, and a planar upper surface; and

an engaging element carried in the body member for engaging a retaining formation of the screening assembly when the body member is inserted into a recessed region defined by abutting ends of a pair of supporting structures.

### BRIEF DESCRIPTION OF THE DRAWINGS

The invention is now described by way of example with reference to the accompanying drawings in which:

FIG. 1 shows a perspective view of a part of a screening assembly, in accordance with an aspect of the invention;

FIG. 2 shows a detail of a part of the assembly of FIG. 1

FIG. 3 shows, on an enlarged scale, a schematic end view illustrating insertion of a locking member of the screening assembly of FIGS. 1 & 2;

FIG. 4(a)-(d) show top and side views and a detail view of a part of a screening module support structure, in accordance with another aspect of the invention;

FIG. 5(a)-(d) show a perspective view, a top view a partial section and a detail view of a part of an intermediate rail, in accordance with yet a further aspect of the invention;

FIG. 6(a)-(d) show a perspective view, a top view a partial section and a detail view of a locking member, in accordance with yet a further aspect of the invention;

FIG. 7 (a)-(e) show top and side views and a detail view of a part of a removable screening element, in accordance with another aspect of the invention;

FIG. 8 shows a top view of a part of the screening assembly of FIG. 1;

FIG. 9(a)-(d) show section and detail views of the assembly of FIG. 7.

### DETAILED DESCRIPTION OF A SCREENING ASSEMBLY

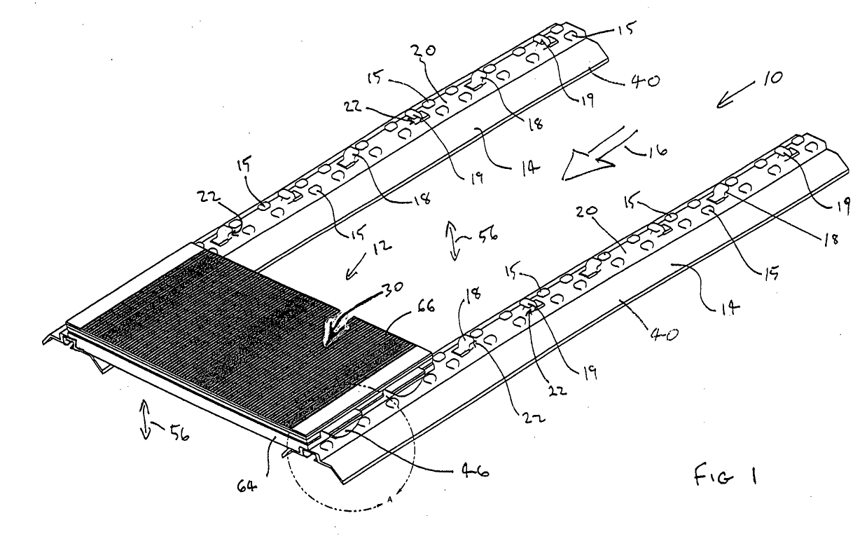

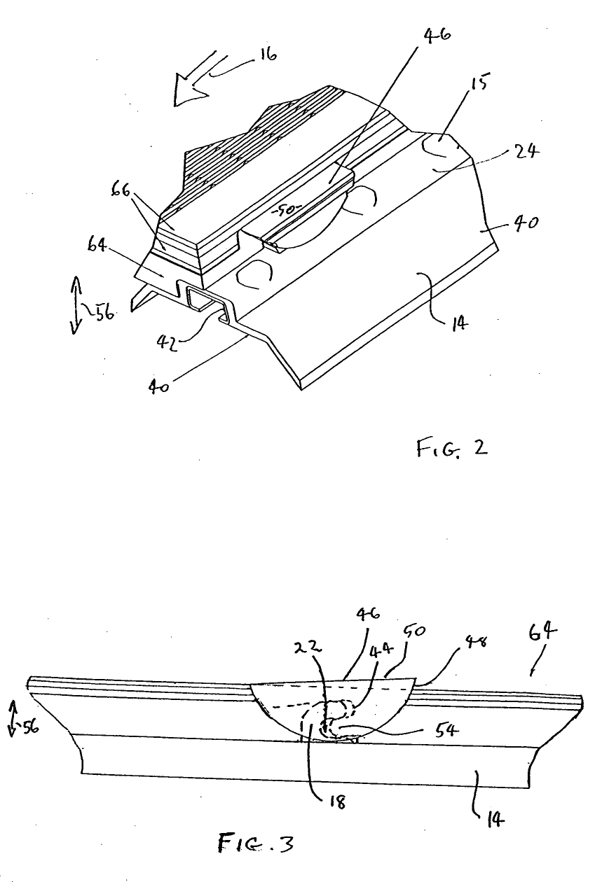

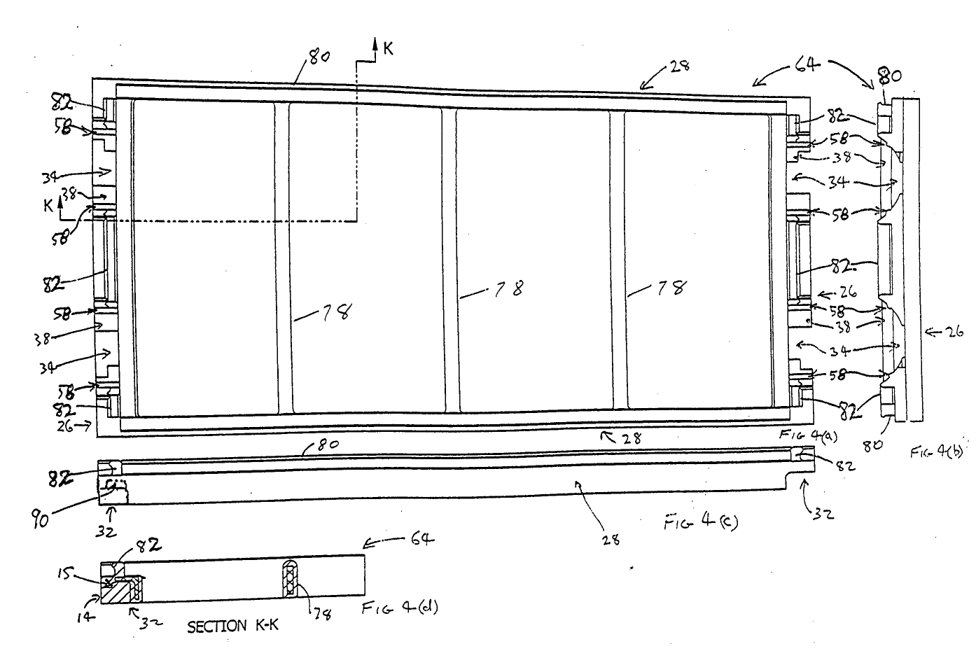

An embodiment of a screening assembly 10, in accordance with a first aspect of the invention is described below, with reference to FIGS. 1 to 8. The screening assembly 10 comprises a plurality of screening modules 12 in accordance with a second aspect of the invention, one of which is shown in FIG. 1 of the drawings. The screening modules are usually mounted on a sub-frame (not shown) of a screening machine (also not shown). The sub-frame and the screening machine are well known in the art and are not described any further.

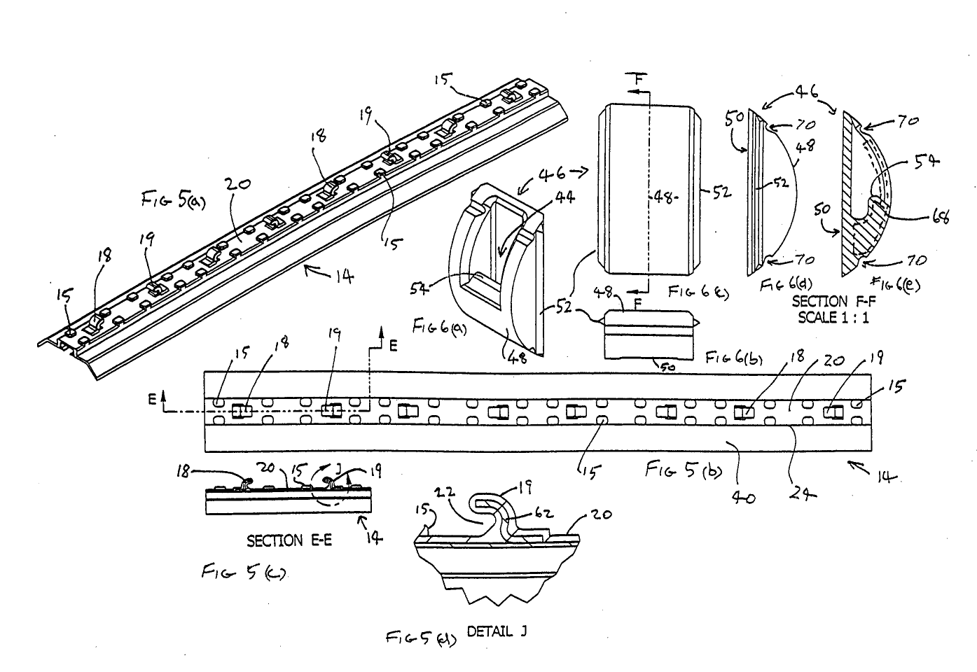

The modules 12 each comprise a supporting structure 64 which comprises a third aspects of the invention, an example of which is shown in FIG. 4 and a removable screening element 66 which comprises a fourth aspect of the invention, and an example of which is shown in FIG. 4.

The modules 12 may be secured to the sub-frame of the machine in end-to-end abutting relationship by means of intermediate rails 14, in accordance with a fifth aspect of the invention, one of which is shown at 14 in FIG. 5 of the drawings.

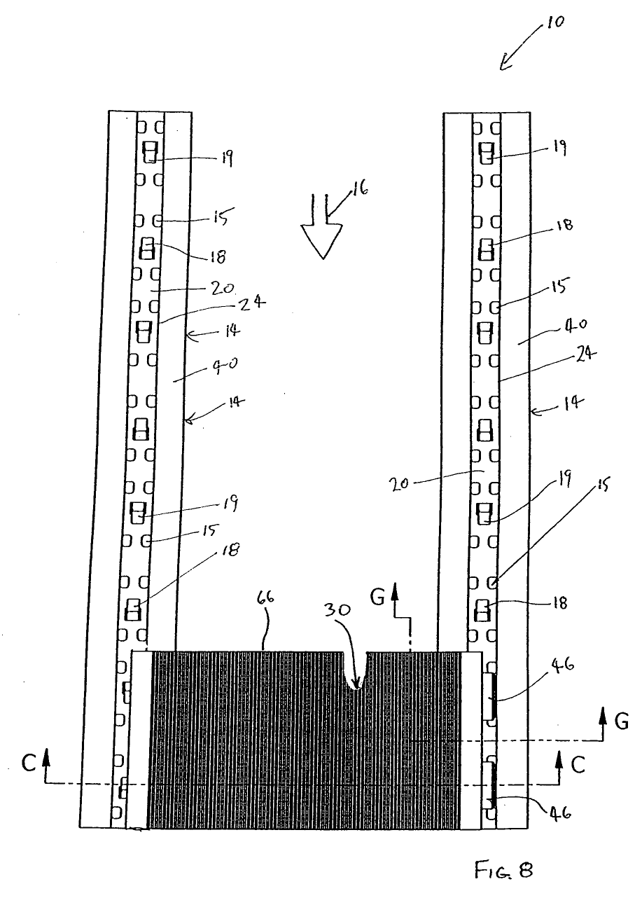

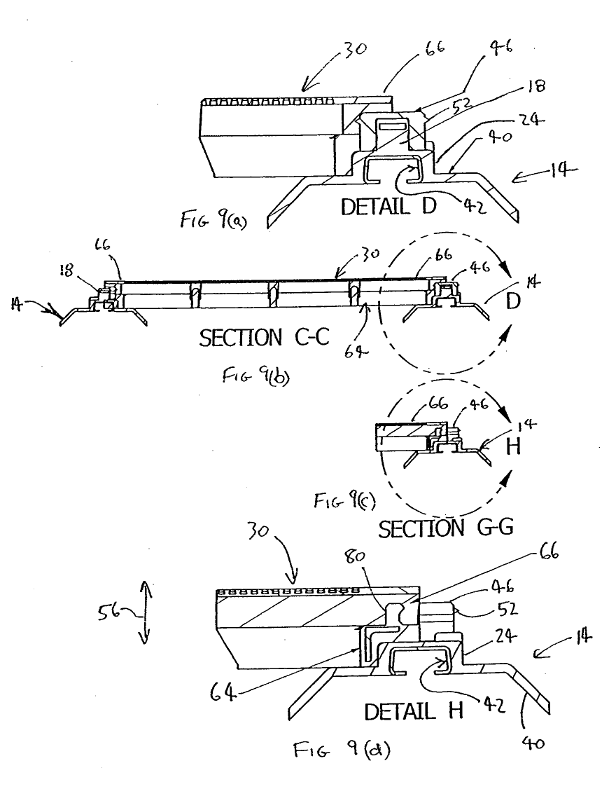

In addition to pairs of modules 12 being arranged in end-to-end relationship, the screening modules 12 are also usually arranged in side-by-side relationship to form a screening surface over which material to be sorted and screened passes. The screening modules 12 are usually arranged with their shorter sides in a direction of flow of the material to be screened, as indicated by arrow 16 in FIGS. 1 and 8 of the drawings.

Commonly the intermediate rails 14 are arranged in spaced parallel relationship extending in the direction of flow 16 of the material although in some cases they may be arranged transversely to the flow direction 16.

Each intermediate rail 14 carries a plurality of retaining formations such as hooks 18, 19 thereon. There may be two oppositely facing hooks 18, 19 arranged for each pair of end-to-end abutting modules 12 in the array of screening modules forming the screening surface. However, if desired, each pair of end-to-end abutting modules 12 could have a single hook or alternatively more than two longitudinally spaced (in the direction of flow 16 of the material) hooks 18, 19.

Preferably each hook 18, 19 stands proud of an upper surface 20 of its associated intermediate rail 14 and has a groove 22 defined therein. The rail 14 comprises an elongate member 24 which may have a generally rectangular cross-section and each hook 18, 19 is mounted on the upper surface 20 of the rectangular cross-section member 24. The hooks 18, 19 are preferably arranged along a longitudinal axis of the rectangular cross-section member 24. The rectangular cross-section member is preferably formed on a C-section metal reinforcing member 42 such that the rectangular cross-section member is hollow and open on the side opposite the surface carrying the retaining formations. The rails 14 may also be provided with a pair of flanges 40 which, in use, extend out beyond the extremities of the sub-frames to which the rails are mounted, to protect the sub-frame from the material being screened, to thereby reduce wear of the sub-frame.

Referring now to FIG. 1 of the drawings, the module 12 and its component parts is described in greater detail. The module 12 comprises a supporting structure 64 (see also FIG. 4) and a removable screening element 66 (see also FIG. 9). The supporting structure 64 is substantially rectangular having a pair of shorter sides or ends 26 and a pair of longer sides 28. The sides 28 and the ends 26 bound the module and the removable screening element 66 preferably extends out to end flush with the sides 26, 28 to provide a screening surface 30 of the module 12.

The ends 26 of the support structure 64 may be undercut to form a step region 32, as clearly illustrated in FIGS. 1, 2 and 4(c) and (d) so that the ends 26 of the support structure 64 can overlie the rectangular cross-section member 24 of the rail 14 with pairs of the support structures 64 abutting to form a channel (not shown) comprising the two undercut areas 32. Preferably also a plurality of lugs 15 may project from the surface 20 of the rectangular cross-section member 24 from which the hooks 18, 19 project. Referring to FIGS. 4(c) and 4(d), these lugs 15 co-operate with recesses 90 provided in the under surfaces of the stepped ends of the supporting structures such that the recesses 90 snugly fit over the lugs 15 to locate the supporting structure on the rail and restrain it against movement in the flow direction 16. It will be appreciated that the lugs 15 and recesses 90 may be swapped between the support structure 64 and the rail 14 while providing similar functionality and in some embodiments the lugs and recesses may not be required.

Receiving formations in each end 26 of the support structure 64 may each define a slot 34 such that when the support structures 64 are aligned in abutting relationship, the slots 34 of the abutting support structures 64 combine to form an opening through which one of the hooks 18, 19 of the rail 14 pass.

An upper end of the slots 34 open out into a floor of parts of recessed regions 38 defined in the end 26 of the abutting supporting structures 64. The recessed regions 38 may be arcuate or half-moon shaped (i.e. they have the shape of a sector of a circle or they may be semi-circular).

Once again, when the recessed regions 38 are aligned, i.e. when the supporting structures 64 of a pair of modules 12 are arranged in end-to-end abutting relationship, the two abutting recesses 38 may define a substantially half-cylindrical shaped recess in which a locking member 46, in accordance with a fourth aspect of the invention, is received.

The locking member 46 preferably has a similarly half-moon shaped lower peripheral portion 48 (i.e. it has the shape of a sector of a circle or it may be semi-circular) and a substantially planar top surface 50. The dimensions of the arcuate, half-moon portion 48 of the locking member 46 may be similar to those of the recesses 38 to fit snugly in the abutting arcuate recesses 38.

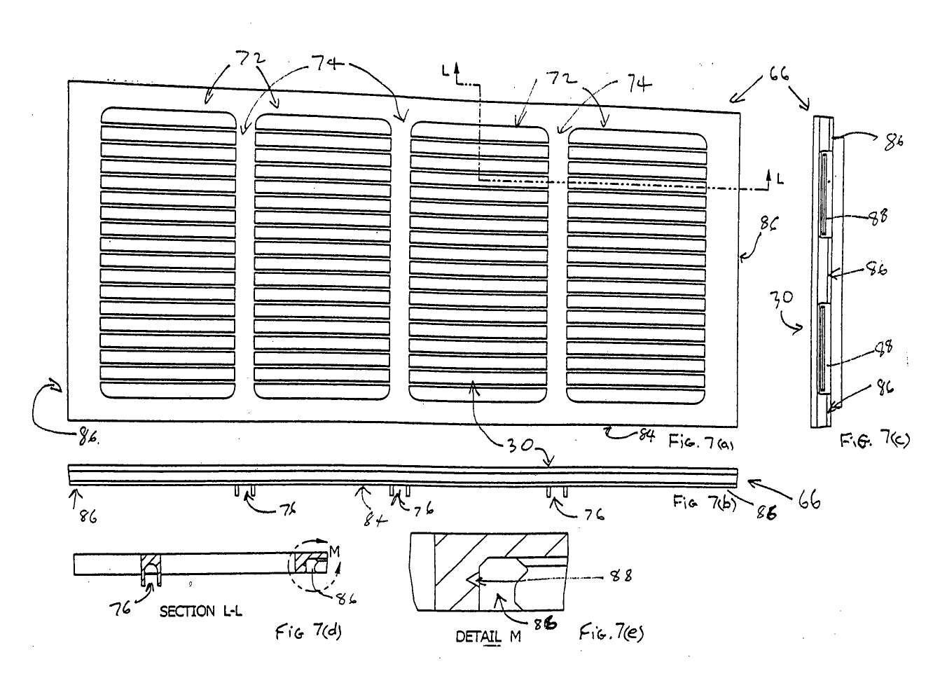

Preferably a centrally arranged opening 44 in the locking member 46 defines an inner surface of an engaging member or finger 54 (FIG. 6). When this locking member 46 is driven home into the abutting recesses 38, the finger 54 is received in the groove 22 of the hook 18 (or the reverse facing hook 19) to lock the pairs of modules 12 against movement in the direction of arrows 56 (FIG. 6).

Also, when the locking member 46 is inserted fully into the abutting recesses 38, its upper surface 50 may lay substantially flush with or below the upper edges of the supporting structure 64 so as not to interfere with the subsequent attachment of the removable screening element 66.

To facilitate insertion of the locking member 46 into the abutting recesses 38, a pair of transverse ribs 58 may be defined in each recess 38 in each end 26 of the module 12. These ribs 58 act as bearing points for the respective locking member 46. They may also act as detents which co-operate with recesses 70 in the acuate peripheral surface 48 of the locking member to keep the locking member 46 in a locking condition in the abutting recesses 38.

It is to be noted that the rectangular cross-section member 24 of the rail 14 may be coated with a plastics material, more particularly, polyurethane. Similarly, the hooks 18, 19 may be formed from a plastics-coated metal element.

The locking member may have reinforcing elements 60 therein. Similarly, the finger 54 may also have a reinforcing bar 62 arranged therein.

The locking member 46 is preferably formed of a plastics material, more particularly, polyurethane as is each supporting structure 64. The polyurethane from which the locking member 46 is made is preferably selected to be harder than the polyurethane from which the supporting structure 64 is made to inhibit binding of the locking member 46 in the recesses 38. For example, the polyurethane from which the module 12 is made may be selected to have a Shore Hardness of 85-93 A whereas the polyurethane from which the locking member is made may have a Shore Hardness of 95 A or a Shore D-scale Hardness of 60-65. The locking member may optionally also incorporate an internal metal reinforcing member 68 to strengthen it.

Referring to FIG. 4, the supporting structure 64 may be provided with a first pair of profiled peripheral projections 80 extending from the upper surface of the supporting structure along its long ends 28 and a second pair of interrupted profiled peripheral projections 82 intermittently projecting from the upper surface of the supporting structure from along its short edges 26, the interrupted profiled peripheral projection extending between the recesses 38 in the shorter ends 26 of the supporting structure 64. These profiled projections 80, 82 are provided to retain a removable screening element 66 and co-operate with similarly profiled recesses 82 in the screening element.

The supporting structure 64 may also carry a number of supporting members 78 running parallel to the short edges 26 of the supporting structure to add rigidity to the supporting structure and to support the centre of the removable screening element. In the illustrated embodiment there are three such supporting members but different embodiments may be provided with a larger or smaller number of supporting members and may also have one or more supporting members running perpendicularly to the short edges or possibly on a diagonal to the edges of the supporting structure.

Referring to FIG. 7, the removable screening element 66 comprises a screening surface 30, in this example formed as four apertured screen segments 72 separated by U shaped ribs 74. The ribs 74 locally blank off the surface of the screening element and project from the underside of the element, each having an opening 76 arranged to sit over a frame member 78 of the supporting structure 64 when the screening element is fitted to the supporting structure. The periphery of the screening element along its long edge may be provided with retention slots 84 having a profile matched to a profiled peripheral projection 80 on the supporting structure, and the short edges may have similar profiled slots 86 in positions corresponding to the locations of the profiled projections 82 between the recesses 38 in the supporting structure 64.

The profiled slots 84, 86 fit over the profiled projections 80, 82 to secure the removable screening element to the supporting structure, and the openings 76 in the U shaped ribs 74 engage the supporting members 78 to reduce vibration of the screening element in use, while the supporting members 78 support the centre of the screening element.

Depending on the application to which the screening assembly is to be put, the frame member 78 may be sized to provide a loose fit within the openings 76 or alternatively it may be provided with projections which engage the walls of the opening 76 to releasably connect the ribs 74 to the frame members 78 in use.

Where the screening element 66 extends over the retaining members 46, a portion of an end surface of the screening element 66, which is an extension of a surface of a wall of the profiled recess 84, may be provided with a groove 88 which has a similar profile to projections 52 on the locking member 46. The grooves 88 and projections 52 co-operate to resist rotation of the locking member 46 when the screen is in use. Also if the locking member 46 is not rotated into the fully locked position, such that the projection 52 cannot align with the groove 88, the projection 52 may interfere with the seating of the removable screening element thereby providing an indication of the incomplete locking of the locking member 46.

It is an advantage of the system described herein that an assembly 10 is provided where the modules 12 are secured to an intermediate rail 14 with a positive locking action by the locking member 46. In addition, the locking member 46 in use sits at or below the level of an upper edge of the supporting structure 64 so that it does not interfere with the fitting of the removable screening element 66. Further, the locking member 46 may be inserted and removed without the need for any special tools. It will be appreciated that the locking member 46 may be removed from the recesses 38 using a screwdriver.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A screening assembly including:
at least one rail to be secured to a screening machine;
at least one retaining formation an upper surface of said at least one rail;
a plurality of screening modules, each screening module comprising:
a supporting structure; and
a removable screening element attached to the supporting structure;
the supporting structure having an end supported on said at least one rail so that a pair of supporting structures lie in end-to-end abutting relationship overlying the at least one rail and defining a receiving formation through which the at least one retaining formation protrudes into a recessed region defined by the abutting ends of the pair of supporting structures; and
a locking member receivable in said recessed region

2. The assembly of claim 1 which includes a plurality of retaining formations arranged at longitudinally spaced intervals along the length of the rail, at least one retaining formation being associated with each pair of screening modules.

3. The assembly of claim 1 in which said ends of the screening modules are shorter sides of the screening modules which are received over their associated rails.

4. The assembly of claim 1 in which each retaining formation is in the form of a hook defining a groove within which an engaging part of the locking member is received.

5. The assembly of claim 4 in which the engaging part of the locking member is a tongue which extends transversely to the ends of the screening modules to engage the hook of the associated retaining formation.

6. The assembly of claim 4 in which the recessed region, when viewed in a vertical plane, is substantially half moon shaped.

7. The assembly of claim 6 in which the locking member has a complementary half moon shape with a flat upper surface to be snugly received in the recessed region with the upper surface of the locking member lying at or below a level of an upper edge of the supporting structure.

8. The assembly of claim 7 in which a floor of the recessed region carries transverse ribs on which the locking member is received and relative to which the locking member can slide to facilitate locking insertion of the locking member into the recessed region.

9. The assembly of claim 8 in which grooves are provided in the locking members to engage the transverse ribs on the floor of the recessed region when the locking member is in a locked position.

10. The assembly of claim 1, in which a surface of the removable screening element carries restraining formations and a facing surface of the locking member carries co-operating complementary formations which engage the restraining formations when the removable screening element is attached to the supporting structure such that the locking member is restrained against rotational motion in use.

11. The assembly of claim 1 in which each end of the supporting structure defines a part of the receiving formation and recessed region so that, when the two modules are placed in end-to-end abutment, the completed receiving formation and recessed region are formed.

12. The assembly of claim 1 in which each rail comprises a rectangular cross-section member with the retaining formations being secured to a wider face of the rectangular cross-section member.

13. The assembly of claim 1 in which an operatively lower surface of each supporting structure is stepped at its end to overlie the rail so that, when the supporting structures are arranged in end-to-end abutment, a channel is formed within which the rail is received.

14. The assembly of claim 1 in which the rail and its associated retaining formations are of metal-reinforced plastics material.

15. The assembly of claim 1 in which the locking member is of a plastics material.

16. The assembly of claim 1 in which the locking member is has metal reinforcing therein.

17. The assembly of claim 16 in which the supporting structures are of a plastics material suitably reinforced.

18. The assembly of claim 17 in which the hardness of the plastics material used for the locking member differs from that of the supporting structures to inhibit binding of the locking member relative to its associated supporting structures.

19. The assembly as claimed in claim 1 wherein the removable screening element is of plastics material.

20. A screening module for a screening assembly, the screening module including:
a supporting structure having a pair of opposed ends;
a removable screen located over the supporting member;
a part of at least one receiving formation defined in at least one of the ends of the supporting structure, the part of the receiving formation, operatively co-operating with a corresponding part of a receiving formation of a supporting structure of a similar module arranged in end-to-end abutment; and
a part of a recessed region associated with the, or each, receiving formation in said at least one end of the supporting structure, the part of the recessed region similarly co-operating with a corresponding part of a recessed region of the supporting structure of the identical module when arranged in end-to-end abutment.

21. The screening module of claim 20 in which a floor of the recessed region carries transverse ribs arranged to act as runners on which the locking member is to be received and relative to which the locking member can slide to facilitate locking insertion of the locking member into the recessed region.

22. The screening module of claim 20 in which a surface of the removable screening element carries restraining formations arranged to operatively co-operate with complementary formations on a facing surface of the locking member to restrain the locking member against rotational.

23. The screening module as claimed in claim 20, in which said part of the recessed region is in shape, a sector of a circle or semi-circular, in a plane of the at least one end of the supporting structure;

24. A supporting structure of a screening module for a screening assembly, the supporting structure including:
a frame having a pair of opposed ends and arranged to receive a removable screen located over the supporting member;
a part of at least one receiving formation defined in at least one of the ends of the frame, the part of the receiving formation, operatively co-operating with a corresponding part of a receiving formation of a frame of a similar supporting structure arranged in end-to-end abutment; and
a part of a recessed region associated with the, or each, receiving formation in said at least one end of the frame, the part of the recessed region similarly co-operating with a corresponding part of a recessed region of the frame of the identical supporting structure when arranged in end-to-end abutment.

25. The supporting structure of claim 24 in which each end of the supporting structure is stepped at its lower edge to overlie a support member of the screening assembly.

26. The supporting structure of claim 24 which a floor of the recessed region carries transverse ribs arranged to act as runners on which the locking member is to be received and relative to which the locking member can slide to facilitate locking insertion of the locking member into the recessed region.

27. The supporting structure of claim 24 in which said part of the recessed region is in shape, a sector of a circle or semi-circular, in a plane of the at least one end of the frame;

28. A removable screening element of a screening module for a screening assembly, the screening module comprising a supporting structure having a pair of opposed ends, a part of at least one receiving formation defined in at least one of the ends of the supporting structure, the part of the receiving formation operatively co-operating with a corresponding part of a receiving formation of a supporting structure of a similar module arranged in end-to-end abutment; and
a part of a recessed region associated with the, or each, receiving formation in said at least one end of the supporting structure, the part of the recessed region similarly co-operating with a corresponding part of a recessed region of the supporting structure of the identical module when arranged in end-to-end abutment, said part of the recessed region being in shape, a sector of a circle or semi-circular, in a plane of the at least one end of the supporting structure, the screening element comprising:
a planar perforated screening member arranged with attachment means around its periphery for removable attachment to a said supporting structure.

29. The removable screening element of claim 28 in which a surface of the removable screening element carries restraining formations arranged to operatively co-operate with complementary formations on a facing surface of the locking member to restrain the locking member against rotational.

30. An intermediate rail for a screening assembly, the intermediate rail including:
an elongate element to be secured to a screening machine; and
at least one retaining formation standing proud of a surface of said elongate element.

31. A locking member for a screening assembly, the locking member including:
a body member having an arcuate periphery, when viewed from a side of the body member, and a planar upper surface; and
an engaging element carried in the body member for engaging a retaining formation of the screening assembly when the body member is inserted into a recessed region defined by abutting ends of a pair of supporting structures.

32. The locking member of claim 31 in which a surface of the locking member carries restraining formations arranged to operatively co-operate with complementary formations on a facing surface of the removable screening element to restrain the locking member against rotational.

33. The locking member of claim 32 wherein the restraining formations are elongate projections parallel to the flat side of the locking member.

34. The locking member of claim 31 wherein a recess is provided in the arcuate periphery for engaging a projection in a recess of the supporting structure in which the locking member is to be located.
